(19) United States
(12) Patent Application Publication
(10) Pub. No.: US 2016/0257825 A1
(43) Pub. Date: Sep. 8, 2016

(54) Anionic Fatty Amides Used As A Dispersant For Pigment Preparations

(71) Applicant: CLARIANT INTERNATIONAL LTD, Muttenz (CH)

(72) Inventor: Hendrik AHRENS, Kriftel (DE)

(73) Assignee: Clariant International Ltd., Muttenz (CH)

(21) Appl. No.: 15/027,936

(22) PCT Filed: Sep. 11, 2014
(86) PCT No.: PCT/EP2014/002468

§ 371 Date: Apr. 7, 2016

(30) Foreign Application Priority Data
Oct. 11, 2013 (DE) 10 2013 016 889.9

(51) Int. Cl. C09D 7/12; C09D 17/00; C09D 5/14

(52) U.S. Cl. CPC C09D 7/1233; C09D 5/14; C09D 17/001

(57) ABSTRACT

The invention relates to aqueous, binder-free pigment preparations containing at least one anionic fatty amide of formula (I), where R is a linear or branched, saturated or unsaturated C₇ to C₁₇-aliphatic hydrocarbon group, A is an anionic group, such as a sulphate, phosphate or methyl-carboxylate group or a sulfosuccinic acid half-ester group, and n represents a whole number between 1 and 30.

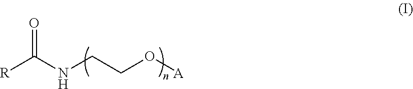

The present invention relates to aqueous binder-free pigment preparations comprising anionic fatty acid amides as dispersants, and also to their use for coloring macromolecular materials of any kind, for example fiber materials, paper furnishes, coatings, varnishes, paints and to their use for printing two-dimensional sheet materials such as, for example, paper, boxboard, plastic, textiles and leather.

Aqueous binder-free pigment preparations for the coloration of macromolecular materials, in particular paints and varnishes, are manufactured using organic or inorganic pigments. The form in which these pigment preparations are used is as tinting pastes in general home improvement and specialist decorating stores, where they are added by means of metering and tinting equipment to aqueous and solvent-borne paints and varnishes in order to color match in accordance with customer wishes. Tinting pastes typically contain pigment concentrations covering a broad range from 1% to 75% by mass.

Although the prior art does propose a multiplicity of compounds as suitable wetting and dispersing agents, in practice there is again and again a dearth of effective dispersants for pigment dispersions to meet expectations of sedimentation resistance, satisfactory rheology, pigment color yield and a low toxicological and ecotoxicological profile. Furthermore, ecolabeling guidelines constrain the use of known wetting and dispersing assistants, and so the skilled person is on the constant lookout for new dispersants and combinations to produce stable liquid aqueous pigment preparations.

WO2013104406 teaches pigment preparations comprising from 0.01 to 15 wt % of at least one fatty acid ethanolamide ethoxylate comprising a linear or branched alkyl or alkenyl moiety of 7 to 21 carbon atoms and 2 to 40 alkoxy groups. The combination of fatty amines with nonionic surfactants and particularly fatty acid amide ethoxylates which is described in WO2013104406 is suitable for inorganic but unsuitable for organic pigments. Furthermore, alkoxylated fatty amines are piscotoxic and classified as hazardous chemicals and required to be labeled as such, which is why the industry is seeking alternative raw materials. This does not apply to the anionic alkoxylated fatty acid amides.

The problem addressed by the present invention was that of producing stable and flowable alkylphenol-free aqueous pigment preparations that have prolonged resistance to the sedimentation of the pigments used and that are capable of coloring aqueous and solventborne paints, varnishes and glazes alike. The pigment preparations of the present invention should not give rise to any rub-out issues when used for tinting aqueous varnishes and paints, in particular emulsion paints, silicate dispersion paints and aqueous silicone resin paints.

The aqueous pigment preparations shall further also be compatible with solventborne varnishes, be homogeneously dispersible in the varnish by mixing, stirring or shaking, and brush or roller apply to surfaces to produce a color image that is solid and uniform. The rub-out test as described in U.S. Pat. No. 3,840,383 is also used to evaluate the aqueous pigment preparations for compatibility.

To maximize the number of paints and varnishes with which the aqueous pigment preparations are compatible, the use of binders shall further be eschewed in the manufacture of pigment preparations according to the present invention.

The problem addressed by the invention was further that of providing aqueous pigment preparations with minimal potential for adverse impact on human toxicology and the environment. Volatile organic compounds having a boiling point of <250° C. (VOC contents) shall not be explicitly added to the aqueous pigment preparations and shall only be present in minimal amounts in the form of unconverted synthons or as secondary reaction products.

It was found that, surprisingly, the problem is solved by mixtures comprising anionic fatty acid amides of formula I.

The invention accordingly provides aqueous binder-free pigment preparations comprising
(A) 1.0 to 75.0 wt % of one or more than one organic or inorganic white or colored pigment or a mixture of various organic and inorganic white or colored pigments,
(B) 0.01 to 8.0 wt % of one or more than one anionic fatty acid amide of formula (I),

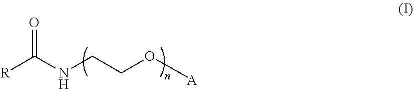

where
R is a linear or branched, saturated or unsaturated C₇ to C₁₇ aliphatic hydrocarbyl moiety,
A is an anionic group preferably selected from sulfate, phosphate, methylenecarboxylate, and sulfosuccinic monoester groups, and
n is an integer from 1 to 30, and
(G) water.

The pigment preparation of the present invention may optionally further comprise one or more of the following ingredients:
(C) 0, preferably 0.01 to 12.0 wt % of a nonionic surfactant,
(D) 0, preferably 0.01 to 8.0 wt % of clay mineral thickener selected from natural or alkali-activated sheet-silicate minerals,
(E) 0, preferably 0.01 to 20.0 wt % of inorganic fillers, and/or
(F) 0, preferably 0.01 to 30 wt % of further customary auxiliaries for producing an aqueous binder-free pigment preparation, such as additional wetting agents, defoamers, rheology additives, preservatives, buffering substances and pH regulators.

The pigment preparations of the present invention are shear-resistant, resistant to drying out, shelf-stable, foam but minimally, if at all, during the application process, and have excellent rheology.

The pigment preparations of the present invention are binder free. Binder herein refers to polymers or resins dispersed or dissolved in a suitable solvent which dry physically, chemically, thermally, oxidatively or on being subjected to radiative curing. As they dry, the polymers or resins form a film and thus bind the pigments and filler used in a coating material. Since binders also have dispersing properties, they are popularly used in combination with low molecular weight wetting and dispersing agents for the manufacture of pigment preparations. The disadvantage with using a binder for the manufacture of pigment preparations is the narrower utility of the pigment preparation, which is supposed to be compatible with a very large number of different paints and varnishes and the binders present therein.

Component (A) in the pigment preparations of the present invention is preferably a finely divided organic or inorganic white or colored pigment or a mixture of various such pigments.

An illustrative selection of particularly preferred organic pigments includes carbon black pigments, e.g., gas or furnace blacks; monoazo and diazo pigments, especially the Color Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and Naphthol AS pigments, in particular the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 254, Pigment Red 256, Pigment Orange 5, Pigment Orange 38 or Pigment Brown 1; laked azo and metal complex pigments, in particular the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, in particular the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, in particular the Colour Index pigments Pigment Yellow 139 or Pigment Yellow 173; phthalocyanine pigments, in particular the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, in particular the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, in particular the Colour Index pigments Pigment Red 169, Pigment Blue 56 or Pigment Blue 61.

Examples of suitable inorganic pigments are titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and of aluminum, rutile mixed phase pigments, sulfides of rare earths, spinels of cobalt with nickel and zinc, spinels based on iron and chromium with copper zinc and also manganese, bismuth vanadates and also blended pigments. It is particularly the Color Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33 and also Pigment White 6 that are used. Mixtures of inorganic pigments are frequently also used with preference. Mixtures of organic with inorganic pigments are likewise used in many cases.

Component (B) in the pigment preparations of the present invention is an anionically substituted fatty acid amide of an optionally ethoxylated fatty acid ethanolamide of formula I

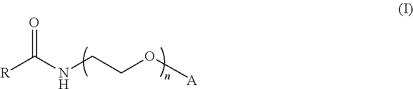

The anionic group A is derived from an acid. The acid is preferably sulfuric acid, phosphoric acid, acetic acid and sulfosuccinic acid.

Ethoxylated fatty acid ethanolamides are obtainable by reaction of fatty acids with ethanolamine to form the fatty acid ethanolamide and subsequent addition thereonto of ethylene oxide using alkaline catalysts such as sodium methoxide or potassium methoxide.

R is preferably an alkyl or alkenyl group of 7 to 17 carbon atoms and may in the case of alkenyl also contain more than one double bond.

n is an integer from 1 to 30 and preferably not less than 2, particularly not less than 3.

Ethylene oxide preferentially adds onto the terminal hydroxyl group of the fatty acid ethanolamide. Ethylene oxide adds onto the nitrogen of the amide group to a minor extent in a secondary reaction, so to a minor extent there are also 2 polyethylene glycol ether moieties attached to the nitrogen. Suitable fatty acids for preparing the fatty acid ethanolamides are capric acid, lauric acid, myristic acid, palmitic acids, stearic acid, arachidic acid, behenic acid, palimtoelic acid, oleic acid and naturally occurring mixtures such as palm kernel oil fatty acid, rapeseed oil fatty acid, sunflower oil fatty acid, soybean oil fatty acid or resin acids such as tall oil fatty acid. The fatty acids used as raw material may be saturated or unsaturated.

The anionic fatty acid amides are subsequently obtained by derivatization.

Suitable anionic fatty acid amides are sulfuric monoesters of formula II,

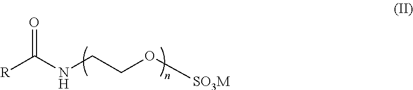

where
R is a linear or branched, saturated or unsaturated C₇ to C₁₇ aliphatic hydrocarbyl moiety,
M is a hydrogen atom, Na, K, ammonium or triethanolammonium ion, and
n is an integer from 1 to 30.

Sulfuric esters are obtainable by reacting the fatty acid ethanolamides or ethoxylated fatty acid ethanolamides with sulfating reagents. Suitable sulfating reagents are sulfur trioxide, chlorosulfonic acid or amidosulfonic acid. After sulfation, the sulfuric monoesters obtained are neutralized with aqueous sodium hydroxide solution, aqueous potassium hydroxide solution, ammonium hydroxide or triethanolamine. Suitable methods of synthesizing sulfuric esters are described in U.S. Pat. No. 2,644,831, U.S. Pat. No. 2,654,772, U.S. Pat. No. 2,758,977 and U.S. Pat. No. 2,214,254.

A method of preparing sulfuric monoesters using sulfur trioxide is described by WO-91/05764. A further method of preparing sulfuric monoesters utilizes amidosulfonic acid as sulfating reagent. The method comprises reacting fatty acid ethanolamides or ethoxylated fatty acid ethanolamides with amidosulfonic acid to form the sulfuric monoester ammonium salt.

Further suitable anionic fatty acid amides are phosphoric esters of formula III,

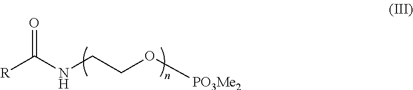

where
R is a linear or branched, saturated or unsaturated C₇ to C₁₇ aliphatic hydrocarbyl moiety,
Me is a hydrogen atom, Na, K, ammonium or alkanolammonium ion, and
n is an integer from 1 to 30.

Phosphoric esters are prepared by reaction of fatty acid ethanolamides or ethoxylated fatty acid ethanolamides with phosphating reagents. Suitable methods of synthesis via the phosphating reaction utilize orthophosphoric acid, polyphosphoric acid, phosphorus pentoxide or phosphoryl chloride as phosphating reagent. The phosphoric esters of fatty acid ethanolamides or ethoxylated fatty acid ethanolamides are mixtures wherein the phosphoric esters may be present as mono-, di- and triesters in addition to unconverted ethanolamide/ethoxylate and phosphating reagent. Phosphoric esters of differing composition are formed depending on the phosphating reagent and the employed molar ratio of fatty acid ethanolamides or ethoxylated fatty acid ethanolamides to phosphating reagent. The synthesis is preferably carried out under conditions chosen so as to maximize the proportion of monophosphoric ester formed.

The phosphoric esters are in acidic form or are neutralized with alkalis. Suitable alkalis are aqueous sodium hydroxide solution, aqueous potassium hydroxide solution, ammonia or alkanolamines. Alkanolamines for neutralizing the phosphoric esters are monoethanolamine (MEA), triethanolamine (TEA), monopropanolamine (MPA), tripropanolamine (TPA), 2-amino-2-methyl-1-propanol (AMP), N,N-diethylethanolamine (DEEA), N,N-dimethylethanolamine (DMEA), N-methyldiethanolamines (MDEA), 2-amino-2-ethyl-1,3-propanediol (AEPD) and 2-dimethylamino-2-methyl-1-propanol (DMAMP). Depending on the established pH, M may also be a mixture of hydrogen atoms and alkali metal cations. The phosphoric esters are present in aqueous solution as mixtures of protonated phosphoric esters, their salts and as deprotonated anions.

Further suitable anionic fatty acid amides are ethercarboxylic acids of formula IV,

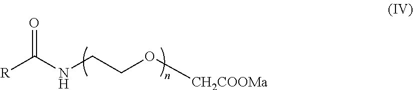

where
R is a linear or branched, saturated or unsaturated C₇ to C₁₇ aliphatic hydrocarbyl moiety,
Ma is a hydrogen atom, Na, K, ammonium or alkanolammonium ion, and
n is an integer from 1 to 30.

Examples of suitable compounds of formula IV are ethercarboxylic acids prepared via direct oxidation or by Williamson's synthesis using sodium monochloroacetate.

Further suitable anionic fatty acid amides are sulfosuccinic monoesters of formula V,

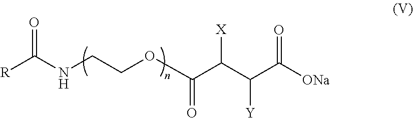

where
R is a linear or branched, saturated or unsaturated C₇ to C₁₇ aliphatic hydrocarbyl moiety,
X and Y are sulfonic acid groups in acidic form or as sodium salt or a hydrogen atom subject to the proviso that X is a sulfonic acid group, Y is a hydrogen atom, and conversely, X is a hydrogen atom when Y is a sulfonic acid group, and
n is an integer from 1 to 30.

Sulfosuccinic monoesters are prepared by reaction of fatty acid ethanolamides or ethoxylated fatty acid ethanolamides with maleic anhydride and subsequently converted into the sulfosuccinic monoester using an aqueous solution of sodium hydrogensulfite.

In a preferred embodiment, the weight ratio between A and B in the composition of the present invention is A:B=1:0.005 to 1:0.5, in particular 1:0.01 to 1:0.3 and specifically 1:0.02 to 1:0.2.

Component (C) in the pigment preparations of the present invention is a nonionic surfactant. It is preferably selected from the group of

fatty alcohol ethoxylates and fatty alcohol alkoxylates,
fatty acid ethoxylates,
fatty acid derivatives,
fatty acid alkanolamide ethoxylates,
sugar surfactants,
alkylpolyglycosides and
polyhydroxy fatty acid amides, especially alkylglucamides.

Suitable nonionic surfactants are fatty alcohol ethoxylates of formula VI,

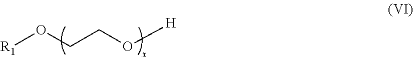

where
R₁ is a linear or branched, saturated or unsaturated C₈ to C₂₂ aliphatic hydrocarbyl moiety,
x is an integer from 1 to 100.

Natural fatty alcohols of 8 to 22 carbon atoms such as octyl alcohol, decyl alcohol, lauryl alcohol, myristyl alcohol, cetyl alcohol, palmitinol, stearyl alcohol, eicosanol, behenyl alcohol, oleyl alcohol, linol alcohol, linolenol, ricinol alcohol or mixtures of C₈ to C₂₂ cuts, for example cocofatty alcohol and palm kernel oil alcohol, are suitable for preparing the fatty alcohol ethoxylates. Synthetic primary alcohols such as iso C₁₃ oxo process alcohols, C₁₃/C₁₅ oxo process alcohols, mixtures of linear, singly branched or multiply branched oxo process alcohols having an average carbon chain length of 10 to 15 carbon atoms, Ziegler alcohols having 8 to 22 carbon atoms and Guerbet alcohols having 10, 12, 14, 16 or 18 carbon atoms and linear and branched secondary alkanols having 6 to 22 carbon atoms are also suitable. The alcohols used may be in a saturated or unsaturated state. The fatty alcohols are reacted with ethylene oxide in a conventional manner by means of alkaline or acidic catalysts. The average degree of ethoxylation of the alcohols is from 1 to 100 mol of ethylene oxide, preferably from 3 to 50 and more preferably from 5 to 30 mol of ethylene oxide.

Further suitable nonionic surfactants are fatty alcohol alkoxylates of formula VII,

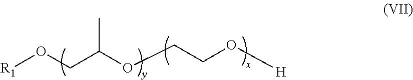

where
R₁ is a linear or branched, saturated or unsaturated C₈ to C₂₂ aliphatic hydrocarbyl moiety,
x and y are each an integer from 1 to 100.

Suitable fatty alcohol alkoxylates are prepared by blockwise addition of propylene oxide and ethylene oxide onto alcohols R₁—OH. The alcohols are preferably reacted first with propylene oxide and then with ethylene oxide.

Further suitable nonionic surfactants are fatty acid alkanolamide ethoxylates of formula VIII,

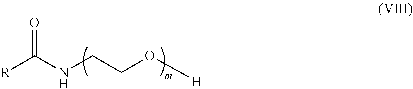

where
R₂ is a linear or branched, saturated or unsaturated C₇ to C₁₇ aliphatic hydrocarbyl moiety, and
m is an integer from 1 to 100.

The ethoxylated fatty acid ethanolamides of component (C) are prepared in the same way as for component (B), while R₂ may be alike or unalike to the composition of R and m may be alike or unalike to n. m is an integer from 1 to 100 and preferably not less than 3, in particular not less than 4.

A further particularly preferred group of nonionic surfactants for component (C) is that of alkyl- and/or alkenyloligoglycosides of formula (IX),

R₃—OG)ₚ (IX)

where R₃ is an alkyl and/or alkenyl moiety having 6 to 22 carbon atoms, G is a sugar moiety having 5 or 6 carbon atoms and p is from 1 to 10. Component (C) may a C₁₂/C₁₄ cocoalkyloligoglucoside.

A further particularly preferred group of nonionic surfactants for component (C) is that of polyhydroxy fatty acid amides of formula (X),

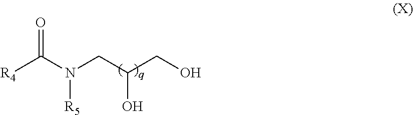

where R₄CO is the acyl moiety of caproic acid, caprylic acid, capric acid, lauric acid, myristic acid, palmitic acid, palmoleic acid, stearic acid, isostearic acid, oleic acid, elaidic acid, petroselic acid, linolic acid, linolenic acid, arachidic acid, gadoleic acid, behenic acid or erucic acid and/or technical grade mixtures thereof. R₅ is a hydrogen atom or a C₁ to C₄ alkyl group and q is 3 or 4. The polyhydroxy fatty acid amides are preferably derived from reducing sugars having 5 or 6 carbon atoms, in particular from glucose, and then constitute fatty acid N-alkylglucamides. Particular preference is given to fatty acid N-alkylglucamides of formula (X), which are obtained by reductive amination of glucose with methylamine and subsequent acylation with C₈/C₁₀ fatty acid mixtures, lauric acid or C₁₂/C₁₄ cocofatty acid and/or a corresponding derivative, for example the alkyl ester thereof.

Further suitable nonionic surfactants are esterification products of polyethylene glycol having an average molecular weight of 200 to 8000 g/mol with natural fatty acids, as well as ethoxylated fatty acid sorbitan esters, castor oil, fatty acid glycerol esters and fatty acid polyglycerol esters.

Component (D) is a clay mineral thickener based on natural or alkali-activated sheet-silicate minerals. Montmorillonite is the essential constituent of bentonite and has a high ion exchange capacity. Smectite and sepiolite are further sheet-silicates.

Admixed with water, the mineral expands by a multiple of its original size, thereby raising the viscosity of the aqueous dispersion. Montmorillonite as clay mineral thickener and other swellable sheet-silicates may be added to the pigment preparation of the present invention in order to slow or prevent the settling out of organic and inorganic pigments and fillers and the effect of syneresis, i.e., the formation of a second phase having a different composition.

Component (E) is an inorganic filler which may be added to the pigment preparations of the present invention in order to increase their density and modify their flow behavior. A pigment preparation comprising a low pigment concentration or lightweight organic pigments may be but difficult to meter in volumetric metering equipment, since the force of gravity is insufficient to empty the liquid pigment preparation into the paint container. In other cases, the viscosity of the pigment preparations having low pigment concentrations is too low, which leads to some dripping. In either case, colorless inorganic fillers may be added to the pigment preparations of the present invention in order to increase the density of the pigment preparation and to improve the flow behavior. Suitable fillers are calcium carbonates such as naturally occurring chalk and precipitated calcium carbonate, dolomite, natural silicon dioxide (quartz flour), pyrogenous and precipitated silicas, diatomaceous earth, aluminas, aluminum hydroxides, talcum, kaolin, mica (potassium aluminosilicate hydrate), barium sulfates such as naturally occurring barytes and precipitated Blanc Fixe.

Components (F) are further customary auxiliaries for the manufacture of aqueous pigment preparation, such as additional wetting agents, moisture retainers, solvents, defoamers, rheology additives, preservatives, buffering substances and pH regulators.

Additional wetting agents may be wetting agents based on polysiloxane ethers, for example a methoxypolyethoxypropyltrisiloxane, alkynediol ethoxylates, fluorosurfactants and also cationic and amphoteric surfactants. Cationic surfactants may be fatty amines, fatty alkylaminopropylamines, fatty amine ethoxylates, quaternary fatty alkylammonium compounds, imidazolinium compounds and morpholinium compounds. Amphoteric surfactants may be betaines such as alkyldimethylcarboxymethylbetaine, amidopropylbetaines and amphoacetates. A particularly suitable group of amphoteric surfactants is that of lecithin and other phosphatides.

Suitable moisture retainers and solvents are preferably glycol ethers, by which herein are meant compounds having ethoxy and/or propoxy groups and having average molar masses between 200 and 20 000 g/mol, in particular polyethylene glycol ethers or polypropylene glycol ethers having an average molar mass between 200 and 20 000 g/mol, mono-, di- or triethylene glycol, mono-, di- or tripropylene glycol, methyl-, ethyl-, propyl-, butyl- or higher alkylpolyalkylene glycol ethers having 1, 2, 3 or more ethylene glycol or propylene glycol units such as, for example, methoxypropanol, dipropylene glycol monomethyl ether, tripropylene glycol monomethyl ether, ethylene glycol monobutyl ether, diethylene glycol monobutyl ether, butylpolyethylene glycol ether, propylpolyethylene glycol ether, ethylpolyethylene glycol ether, methylpolyethylene glycol ether, dimethylpolyethylene glycol ether, dimethylpolypropylene glycol ether, glycerol ethoxylates having a molecular weight of 200 to 20 000 g/mol, pentaerythritol alkoxylates having a molecular weight of 200 to 20 000 g/mol, or further ethoxylation and alkoxylation products and random or block copolymers prepared by addition of ethylene oxide and/or propylene oxides onto monohydric or polyhydric alcohols, with a molecular weight of 200 to 20 000 g/mol.

Disclosures regarding molecular weights of polymers are all based on the number average molecular weight thereof unless indicated otherwise in an individual case. Molecular weights shall be determined by GPC versus polyethylene glycol as standard.

Further suitable auxiliary materials for inclusion in the aqueous pigment preparations of the present invention are preferably water-soluble organic or hydrotropic substances which, where appropriate, also serve as solvents. Particularly suitable are, for example, formamide, urea, tetramethylurea, ε-caprolactam, glycerol, diglycerol, polyglycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate, sodium butyl monoglycol sulfate.

Suitable defoamers are preferably mineral oil defoamers and emulsions thereof, silicone oil defoamers and silicone oil emulsions, polyalkylene glycols, polyalkylene glycol fatty acid esters, fatty acids, polyhydric alcohols, phosphoric esters, hydrophobic modified silica, aluminum tristearate, polyethylene waxes and amide waxes.

Suitable further rheology additives as agents for regulating the viscosity include, for example, starch derivatives, cellulose derivatives and hydrophobic modified ethoxylated urethane (HEUR) thickeners, alkali-swellable acrylate thickeners, hydrophobic modified acrylate thickeners, polymers of acrylamidomethylpropanesulfonic acid or pyrogenous silica.

In-can preservatives are added to stabilize the aqueous pigment preparations and to prevent the uncontrolled growth of bacteria, algae and fungi. Suitable biocides are formaldehyde, formaldehyde-donating compounds, methylisothiazolinone, chloromethylisothiazolinone, benzisothiazolinone, bronopol, dibromodicyanobutane and silver chloride-coated titanium dioxide.

Any buffering substances and pH regulators employed are preferably organic or inorganic bases and acids. Preferred organic bases are amines, e.g., ethanolamine, diethanolamine, triethanolamine, N,N-dimethylethanolamine, diisopropylamine, 2-amino-2-methyl-1-propanol or dimethylaminomethylpropanol. Preferred inorganic bases are sodium hydroxide, potassium hydroxide, lithium hydroxide or ammonia.

Water included as component (G) in the aqueous pigment preparations of the present invention is preferably employed in the form of distilled or demineralized water. Drinking water (tap water) and/or water of natural origin is also employable. The water content of the aqueous pigment preparation of the present invention is preferably in the range from 10 to 75 wt %, in particular ad 100 wt %.

The aqueous pigment preparations of the present invention preferably have a viscosity of from 10 to 10 000 mPas, preferably 30 to 5000 mPas and more preferably 50 to 3000 mPas, as measured with a plate-cone viscometer at a shear rate of 1/60 sec⁻¹, e.g., a Haake Viscometer 550.

The aqueous pigment preparations of the present invention are miscible with water in any proportion, even to the extent where two or more different preparations can be mixed with water. They are superior to conventional pigment preparations by virtue of having an outstanding stability in storage and good rheological properties. The present invention also provides a method of producing the pigment preparations of the present invention, by dispersing component (A) as powder or granules in the presence of water (G) and also components (B), (C) and optionally (D), (E) and (F) in a conventional manner, then admixing further water (G) where appropriate and adjusting the resulting aqueous pigment dispersion with water to the desired concentration. Preferably, the liquid components (B), (C), (G) and optionally (F) are mixed and homogenized before the solid, pulverulent, granulated or flaked components (A), (D) and (E) are stirred into the initially charged mixture, while the pigment and any fillers are pasted up and predispersed. Depending on the grain harshness of the pigments used, this is followed by fine dispersal or disbursal using a grinding or dispersing assembly with or without cooling. Apparatus useful for this purpose includes stirred mechanisms, dissolvers (sawtooth stirrers), rotor-stator mills, ball mills, stirred media mills such as sand and bead mills, high speed mixers, kneaders, rollmill stands or high performance bead mills. The grinding and/or fine dispersal of the pigments is carried on to the desired particle size distribution and may be carried out at temperatures ranging from 0 to 100° C., advantageously at a temperature between 10 and 70° C., preferably at 20 to 60° C. After its fine dispersal, the pigment preparation may be further diluted with water, preferably deionized or distilled water.

The pigment preparations of the present invention are useful for pigmenting and coloring macromolecular materials of any kind. The pigment preparations of the present invention are very useful for pigmentation and/or manufacture of emulsion and other paints, dispersion-based varnishes, printing inks, for example textile, flexographic, decorative or gravure printing inks, wallpaper inks, water-thinnable varnishes, wood stains, wood preservative systems, and coatings for surface coating articles of, for example, metal, wood, plastic, glass, ceramic, concrete, textile material, paper or rubber.

A special trait of pigment preparations according to the present invention is their utility as universal tinting pastes. Universal tinting pastes are useful for both aqueous and solventborne systems. Customary dispersants for aqueous pigment preparations stabilize the pigments in aqueous systems only, not in solventborne systems. When aqueous pigment preparations are used for coloration of solventborne systems, the pigments can agglomerate and the agglomerated pigments can segregate in the paint. As the paint is applied by brushing, rollering or spraying, stripiness and an unsteady color image can come about due to hue differences, since the pigments flocculate in the paint and during the drying process, reducing color strength. As the pigmented coatings are applied, the pigment agglomerates are disagglomerated, but to varying degrees, so the hue differences observed come about. This phenomenon is simulated in the laboratory by the rub-out test described in U.S. Pat. No. 3,840,383.

### EXAMPLES

### Producing a Pigment Preparation

The pigment—whether as powder, granules or presscake—is pasted up with the dispersants and the other additives in deionized water and then homogenized and predispersed with a dissolver (an AE3-M1 model from VMA-Getzmann GmbH, for example) or some other suitable apparatus.

For dispersal, the liquid components, the anionic fatty acid amide component (B), optionally further nonionic dispersants of component (C) and also further components (F) are initially charged to a grinding vessel and mixed. Subsequently, the pulverulent components (A) and optionally (D) and (E) are added and predispersed using the dissolver.

The subsequent fine dispersal is effected using a bead mill (AE3-M1 from VMA-Getzmann, for example) or else some other suitable dispersing assembly, the grinding media used being siliquartzite beads or zirconium mixed oxide beads d=1 mm in size and the grinding process being carried out with cooling to the desired color strength and coloristics. The desired final pigment concentration is subsequently established with deionized water, and the grinding media are separated off and the pigment preparation is isolated.

### Test of Paint Compatibility and Color Strength

The pigment preparation is stored at 60° C. for one week and evaluated by visual inspection. The viscosity of the pigment preparation is measured at 25° C. with a Haake Viscometer 550 at a shear rate of 1/60 sec⁻¹ or, in the case of free-flowable pigment preparations, with a Brookfield DV-II viscometer using spindle 3 at 100 rpm. To determine compatibility and color strength, the pigment preparations are each added to a white aqueous emulsion paint and to a long oil alkyd varnish comprising mineral oil. To test compatibility and color strength, 200 g each of the tinted paints, consisting of 92 wt % of base varnish and 8 wt % of pigment preparation, are placed in a tin can and homogenized for 60 seconds in an Inkshaker 500 from Olbrich Know-how, Hemer. The tinted paints are drawn down after one day on a test card using a 120 μm blade on a 509 MC film-drawing instrument from Erichsen GmbH, Hemer. The drying colored films are subjected to the rub-out test in the manner described in U.S. Pat. No. 3,840,383.

The pigment preparations described in the examples which follow were produced by the method described above, wherein the following constituents were used in the stated amounts such that 100 parts of the particular pigment preparation were obtained. In the present application for a patent, “parts” and percentages are by weight unless stated otherwise in an individual case.

### Examples of Pigment Preparations

### Example 1

50.0 parts of C.I. Pigment Blue 15:3 (Hostaperm® Blue B2G, from Clariant, component (A)),
6.0 parts of phosphated tall oil fatty acid ethanolamide reacted with 5 mol of ethylene oxide (component (B)),
10.0 parts of glycerol ethoxylate having a molecular weight of 300 g/mol (Polyglykol G 300, from Clariant, component (F)),
2.0 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
31.5 parts of water (component (G))

The pigment preparation is liquid, homogeneous and foam free after one week of storage at 60° C. The viscosity of the pigment preparation is 300 mPa·s, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 2

### A Comparative Example

50.0 parts of C.I. Pigment Blue 15:3 (Hostaperm® Blue B2G, from Clariant, component (A)),
6.0 parts of phosphated oleyl alcohol ethoxylate with 5 mol of ethylene oxide (component (B)),
10.0 parts of glycerol ethoxylate having a molecular weight of 300 g/mol (Polyglykol G 300, from Clariant, component (F)),
2.0 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
31.5 parts of water (component (G))

The pigment preparation can be pasted up and liquefied. After grinding, the pigment preparation turns into a solid cake.

### Example 3

50.0 parts of C.I. Pigment Blue 15:3 (Hostaperm® Blue B2G, from Clariant, component (A)),
6.0 parts of phosphated tall oil fatty acid ethanolamide reacted with 3 mol of ethylene oxide (component (B)),
10.0 parts of glycerol ethoxylate having a molecular weight of 300 g/mol (Polyglykol G 300, from Clariant, component (F)),
2.5 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
31.0 parts of water (component (G))

The pigment preparation is liquid, homogeneous and foam free after one week of storage at 60° C. The viscosity of the pigment preparation is 580 mPa·s, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 4

50.0 parts of C.I. Pigment Red 254 (Hostaperm® Red D3G 70, from Clariant, component (A)),
6.0 parts of phosphated tall oil fatty acid ethanolamide reacted with 5 mol of ethylene oxide (component (B)),
10.0 parts of glycerol ethoxylate having a molecular weight of 300 g/mol (Polyglykol G 300, from Clariant, component (F)),
3.5 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
30.0 parts of water (component (G))

The pigment preparation is liquid, homogeneous and foam free after one week of storage at 60° C. The viscosity of the pigment preparation is 520 mPa·s, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 5

30.0 parts of C.I. Pigment Violet 23 (Hostaperm® Violet RL 02, from Clariant, component (A)),
6.0 parts of phosphated tall oil fatty acid ethanolamide reacted with 5 mol of ethylene oxide (component (B)),
10.0 parts of glycerol ethoxylate having a molecular weight of 300 g/mol (Polyglykol G 300, from Clariant, component (F)),
3.5 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
50.0 parts of water (component (G))

The pigment preparation is liquid, homogeneous and foam free after one week of storage at 60° C. The viscosity of the pigment preparation is 205 mPa·s, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 6

50.0 parts of C.I. Pigment Yellow 74 (Hansa® Brilliant Yellow 2GX70, from Clariant, component (A)),
6.0 parts of phosphated tall oil fatty acid ethanolamide reacted with 5 mol of ethylene oxide (component (B)),
10.0 parts of glycerol ethoxylate having a molecular weight of 300 g/mol (Polyglykol G 300, from Clariant, component (F)),
3.5 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
50.0 parts of water (component (G))

The pigment preparation is liquid, homogeneous and foam free after one week of storage at 60° C. The viscosity of the pigment preparation is 560 mPa·s, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 7

50.0 parts of C.I. Pigment Yellow 74 (Hansa® Brilliant Yellow 2GX70, from Clariant, component (A)),
6.0 parts of phosphated tall oil fatty acid ethanolamide reacted with 5 mol of ethylene oxide (component (B)),
10.0 parts of glycerol ethoxylate having a molecular weight of 300 g/mol (Polyglykol G 300, from Clariant, component (F)),
3.5 parts of triethanolamine (neutralizing reagent, component (F)),
0.3 part of defoamer (D-Foam-R C 740, from Clariant, component (F)),
0.2 part of preservative (Nipacide® BSM, from Clariant, component (F)),
50.0 parts of water (component (G))

The pigment preparation is liquid, homogeneous and foam free after one week of storage at 60° C. The viscosity of the pigment preparation is 560 mPas, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 8

70.0 parts of C.I. Pigment Green 17 (Chromoxid Grün GN, from Lanxess, component (A)),
2.0 parts of phosphated tall oil fatty acid ethanolamide reacted with 5 mol of ethylene oxide and neutralized with triethanolamine in a mass ratio of 4:1 (component (B)),
6.0 parts of tall oil fatty acid ethanolamide reacted with 20 mol of ethylene oxide (component (C)),
10.0 parts of glycerol ethoxylate having a molecular weight of 300 g/mol (Polyglykol G 300, from Clariant, component (F)),
0.3 part of defoamer (D-Foam-R C 740, from Clariant, component (F)),
0.2 part of preservative (Nipacide® BSM, from Clariant, component (F)),
11.5 parts of water (component (G))

The pigment preparation is liquid, homogeneous and foam free after one week of storage at 60° C. The viscosity of the pigment preparation is 1.5 Pas, as measured with a Haake plate-cone viscometer. After a further 4 weeks of storage at 25° C. the pigment preparation remains homogeneous and suitable for use as a tinting paste. 8% of pigment preparation are added to both a white aqueous emulsion paint and a long oil alkyd varnish comprising mineral oil and, after commixing, drawn down on a test card using a 120 μm blade. The tinted products are strong in color and do not exhibit any rub-out.

### Example 9

25.0 parts of C.I. Pigment Green 7 (Hostaperm® Green GNX, from Clariant, component (A)),
2.0 parts of phosphated tall oil fatty acid ethanolamide reacted with 3 mol of ethylene oxide (component (B)),
6.0 parts of tall oil fatty acid ethanolamide reacted with 20 mol of ethylene oxide (component (C)),
1.0 part of smectite magnesium sheet-silicate (Bentone EW, from Elementis, component (D)),
15.0 parts of talcum (Microtalc IT Extra, from Mondo Minerals, component (E)),
10.0 parts of glycerol ethoxylate having a molecular weight of 300 g/mol (Polyglykol 300, from Clariant, component (F)),
0.3 part of defoamer (D-Foam-R C 740, from Clariant, component (F)),
0.2 part of preservative (Nipacide® BSM, from Clariant, component (F)),
40.5 parts of water (component (G))

The pigment preparation is liquid, homogeneous and foam free after one week of storage at 60° C. The viscosity of the pigment preparation is 300 mPa·s, as measured with a Brookfield viscometer using spindle 3 at 100 rpm. On tinting with the pigment paste, the white emulsion paint and the long oil alkyd varnish do not exhibit any rub-out. After a further 4 weeks of storage at 25° C. the pigment preparation remains homogeneous and suitable for use as a tinting paste.

### Example 10

13.0 parts of C.I. Pigment Red 112 (Permanents® Red FGR, from Clariant, component (A)),
2.0 parts of phosphated tall oil fatty acid ethanolamide reacted with 3 mol of ethylene oxide (component (B)),
6.0 parts of tall oil fatty acid ethanolamide reacted with 20 mol of ethylene oxide (component (C)),
1.0 part of smectite magnesium sheet silicate (Bentone EW, from Elementis, component (D)),
25.0 parts of talcum (Microtalc IT Extra, from Mondo Minerals, component (E)),
10.0 parts of glycerol ethoxylate having a molecular weight of 300 g/mol (Polyglykol 300, from Clariant, component (F)),
0.3 part of defoamer (D-Foam-R C 740, from Clariant, component (F)),
0.2 part of preservative (Nipacide® BSM, from Clariant, component (F)),
42.5 parts of water (component (G))

The pigment preparation is liquid, homogeneous and foam free after one week of storage at 60° C. The viscosity of the pigment preparation is 270 mPa·s, as measured with a Brookfield viscometer using spindle 3 at 100 rpm. On tinting with the pigment paste, the white emulsion paint and the long oil alkyd varnish do not exhibit any rub-out. After a further 4 weeks of storage at 25° C. the pigment preparation remains homogeneous and suitable for use as a tinting paste.

1. An aqueous binder-free pigment preparation comprising
(A) 1.0 to 75.0 wt % of at least one organic or inorganic white or colored pigment or a mixture of various organic and inorganic white or colored pigments,
(B) 0.01 to 8.0 wt % of at least one anionic fatty acid amide of formula (I), 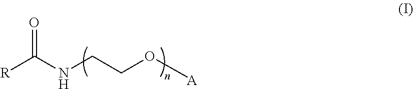
where
R is a linear or branched, saturated or unsaturated C₇ to C₁₇ aliphatic hydrocarbyl moiety,
A is an anionic group, and
n is an integer from 1 to 30, and
(G) water,
wherein the pigment preparation is free from polymers or resins dissolved or dispersed in a suitable solvent and dries physically, chemically, thermally, oxidatively or by radiative curing.

2. The aqueous binder-free pigment preparation as claimed in claim 1 wherein the anionic fatty acid amide is a sulfuric monoester of formula II, 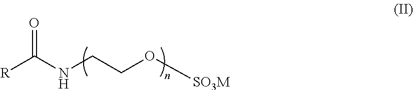
where
R is a linear or branched, saturated or unsaturated C₇ to C₁₇ aliphatic hydrocarbyl moiety,
M is a hydrogen atom, Na, K, ammonium or triethanolammonium ion, and
n is an integer from 1 to 30.

3. The aqueous binder-free pigment preparation as claimed in claim 1 wherein the fatty acid amide is a phosphoric ester of formula III, 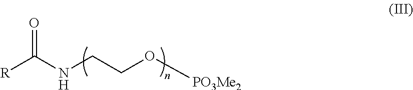
where
R is a linear or branched, saturated or unsaturated C₇ to C₁₇ aliphatic hydrocarbyl moiety,
Me is a hydrogen atom, Na, K, ammonium or alkanolammonium ion, and
n is an integer from 1 to 30.

4. The aqueous binder-free pigment preparation as claimed in claim 1 wherein the anionic fatty acid amide is an ethercarboxylic acid of formula IV, 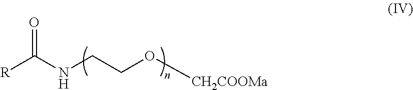
where
R is a linear or branched, saturated or unsaturated C₇ to C₁₇ aliphatic hydrocarbyl moiety,
Ma is a hydrogen atom, Na, K, ammonium or alkanolammonium ion, and
n is an integer from 1 to 30.

5. The aqueous binder-free pigment preparation as claimed in claim 1 wherein the fatty acid amide is a sulfosuccinic monoester of formula V, 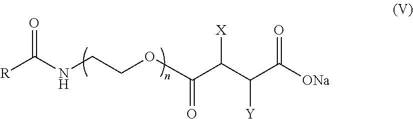
where
R is a linear or branched, saturated or unsaturated C₇ to C₁₇ aliphatic hydrocarbyl moiety,
X and Y are sulfonic acid groups in acidic form or as sodium salt or a hydrogen atom subject to the proviso that X is a sulfonic acid group when Y is a hydrogen atom, and conversely, X is a hydrogen atom when Y is a sulfonic acid group, and
n is an integer from 1 to 30.

6. The aqueous binder-free pigment preparation as claimed in claim 1, further comprising
(C) 0.01-12.0 of a nonionic surfactant selected from the group consisting of
fatty alcohol ethoxylates and fatty alcohol alkoxylates,
fatty acid ethoxylates,
fatty acid esters of polyethylene glycols,
fatty acid alkanolamide ethoxylates,
sugar surfactants,
alkylpolyglycosides,
polyhydroxy fatty acid amides, and
ethoxylation products of fatty acid sorbitan esters, castor oil, fatty acid glycerol esters and fatty acid polyglycerol esters.

7. The aqueous binder-free pigment preparation as claimed in claim 3, comprising from 1 to 7 wt % of a phosphoric ester of formula (III).

8. The aqueous binder-free pigment preparation as claimed in claim 1, comprising from 10 to 75 wt % of water.

9. The aqueous binder-free pigment preparation as claimed in claim 1, which has a viscosity of from 10 to 10 000 mPas, determined with a plate-cone viscometer at a shear rate of 1/60 sec⁻¹.

10. The aqueous binder-free pigment preparation as claimed in claim 1, further comprising
(D) 0.01-8.0 wt % of clay mineral thickeners selected from natural or alkali-activated sheet-silicate minerals.

11. The aqueous binder-free pigment preparation as claimed in claim 1, further comprising
(E) 0.01-20.0 wt % of inorganic fillers.

12. The aqueous binder-free pigment preparation as claimed in claim 1, further comprising
(F) 0.01 to 30 wt % of further customary auxiliaries for producing an aqueous binder-free pigment preparation which are selected from the group consisting of wetting agents, moisture retainers, solvents, defoamers, rheology additives, preservatives, buffering substances and pH regulators.

13. The aqueous binder-free pigment preparation as claimed in claim 12, comprising up to 15 wt % of the moisture retainer/solvent, wherein the moisture retainer/solvent is selected from the group consisting of glycol ethers of 200 to 20 000 g/mol number average molecular weight.

14. The aqueous binder-free pigment preparation as claimed in claim 12, comprising up to 2 wt % of defoamer.

15. The aqueous binder-free pigment preparation as claimed in claim 12, comprising up to 1 wt % of an in-can preservative.

16. A for pigmenting a macromolecular material, coating, paint and varnish for printing two-dimensional sheet materials comprising the step of adding an aqueous binder-free pigment preparation as claimed in claim 1 to the macromolecular material, coating, paint and varnish.

17. The aqueous binder-free pigment preparation as claimed in claim 1, further comprising alkylglucamides,
